(19) United States
(12) Patent Application Publication
(10) Pub. No.: US 2012/0073146 A1
(43) Pub. Date: Mar. 29, 2012

(54) Cover for an edge trimmer apparatus

(76) Inventor: Michael J. Hebert, New Iberia, LA (US)

(21) Appl. No.: 12/924,313

(22) Filed: Sep. 25, 2010

(51) Int. Cl. B26B 29/00; B23P 17/00

(52) U.S. Cl. 30/286; 29/401.1

(57) ABSTRACT

A cover for a trimmer head of a landscape trimmer has a diameter at least slightly greater than the diameter of the retaining assembly, which extends outwardly from the bottom plate. The retaining assembly engages with the knob of the trimmer head, while the cutting line spool is positioned between the cover and the knob. The bottom plate forms an enlarged collar surrounding the retaining assembly and prevents damage to lawn and soil during an occasional contact with the trimmer head.

### BACKGROUND OF THE INVENTION

This invention relates to an accessory to a clearing apparatus for use in vegetation clearing operations. The invention further relates to a cover device for use in a landscape trimmer apparatus. The accessory device of this invention is, in one aspect, in the form of a bottom cover to a cutter head of an edge trimmer apparatus.

Generally, landscape trimmers are used to cut grass and weeds, and are often used to edge around trees, near fences and walls, and along landscape borders. There are many devices that have been used in the care and maintenance of commercial and residential lawns. For example, there are mowers and various types of trimmers. Older landscape trimmers employed metal blades as a cutting mechanism at first, but eventually developed such that the cutting mechanism was some sort of synthetic string.

The earlier edge trimmer had safety deficiencies in that the trimmers tended to be small pieces of equipment, which were close to the body or its appendages. And, none of these smaller trimmers or hedgers provided any sort of guide which allowed the user ease of operation, saving time, or an “even” trim.

Another disadvantage of the older models was that most attachments for trimmers were shields primarily for safety. However, the shield did not make the work easier nor did the shield provide the ability for an “even trim.” Furthermore, most attachments were manufactured and pre-attached to the trimmer prior to reaching the consumer.

As technology progressed, trimmers with longer handles appeared such that there was a handle and engine at one end of a long shaft and the trimming mechanism at the distal end of the shaft. Modern conventional landscape trimmers have an elongated shaft with a rotating element or cutter head near the end of the elongated shaft, and a spool or string head is attached to the cutter head. Conventional string head includes a monofilament line or other cutting devices that are rotated by the gear head for cutting and trimming along landscaped areas, fences, and walls.

The string head is mounted in a housing that comprises a hollow upper housing portion or knob and a hollow lower housing portion or cover. The knob and the cover snap together around the string head, while the cutting filament projects from opposing openings formed in the knob. Conventional housings have a small diameter cover, which upon contact with the ground tends to leave a gouge mark, which is unsightly and damaging to the lawn.

The present invention contemplates elimination of drawbacks associated with conventional edge trimmer and provision of a cover that protects the lawn in case of an occasional contact with the cutter head.

### SUMMARY OF THE INVENTION

These and other objects of the invention are achieved through a provision of a replacement cover for use with trimmer heads.

It is another object of the invention to provide a cover for a grass trimmer apparatus that can easily replace conventional covers in certain models of trimmer heads.

These and other objects of the invention are achieved through a provision of a cover for a trimmer head of a landscape trimmer that has a diameter at least slightly greater than the diameter of the retaining assembly, which extends outwardly from the bottom plate. The retaining assembly engages with the knob of the trimmer head, while the cutting line spool is positioned between the cover and the knob. The bottom plate forms an enlarged collar surrounding the retaining assembly and prevents damage to lawn and soil during an occasional contact with the trimmer head.

### BRIEF DESCRIPTION OF THE DRAWINGS

Reference will now be made to the drawings, where like parts are designated by like numerals, and wherein

FIG. 1 is a perspective view of the cover device for a grass trimmer apparatus according to the present invention.

FIG. 2 is a perspective view of the cover device of the present invention, with the knob of a trimmer head shown in phantom lines.

FIG. 3 is a cross sectional view of the cover device according to the present invention, where the spring is not a part of the instant invention.

### DETAIL DESCRIPTION OF THE INVENTION

Turning now to the drawings in more detail, numeral 10 designates a cover for a trimmer head according to the present invention. It should be noted that the compression spring shown in the drawings does not form a part of the instant invention but is shown for illustrative purposes. While the cover 10 is of the type adapted for use with trimmer heads made by Shindaiwa, it will be appreciated that the cover device of this invention can have application in regard to either straight shaft or curved shaft trimmers made by other manufacturers such as Toro, John Deere, Ryobi, Echo, and others merely by adapting the cover engagement means so that the required trimmer head can be modified or retrofitted with the cover 10. Depending upon the manufacturer of the trimmer, the cover 10 may also require a change in shape or configuration so that the cover device can be mounted on the knob of the trimmer head in accordance with the objectives of this invention.

The cover device 10 forms a bottom portion of a generally cylindrical hollow trimmer head 12, which comprises an upper portion or knob 14 and a string head or spool mounted inside the knob, between the knob 14 and the cover device 10. The spring head is designed to retain a length of a filament or a cutting line 18, which is wound on the spool.

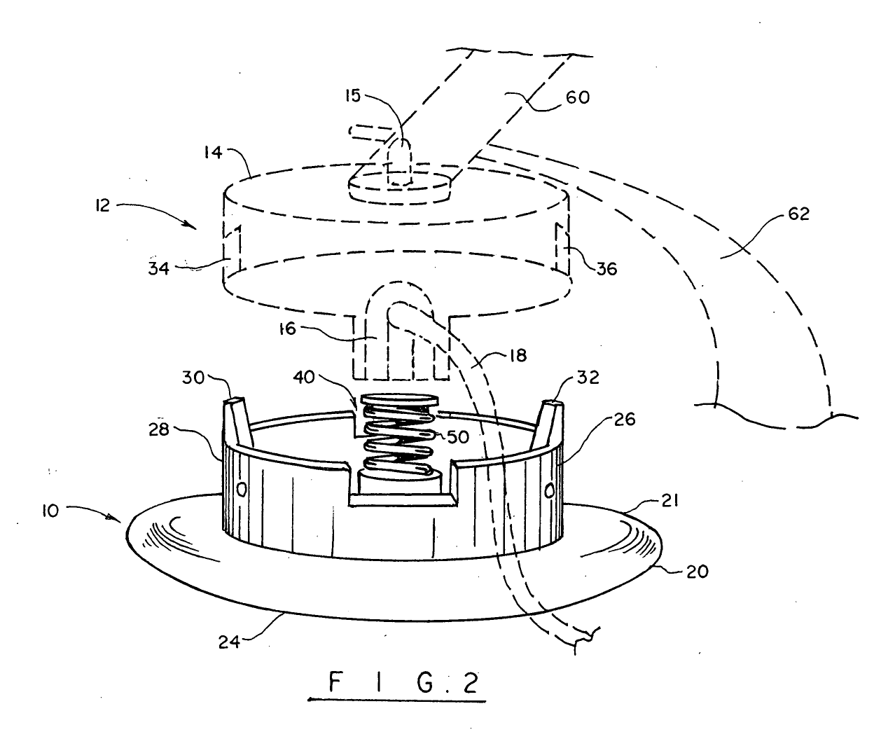

Two eyelets 16 secured to the knob 14 at diametrically opposite locations (only one such eyelet is shown in FIG. 2) guide the cutting line 18 from the housing 12. In some models, the line can be loaded automatically by guiding a long length of line through one of the eyelets 16 out through the other eyelet, then twisting the top of the trimmer head 14 in a pre-determined direction, while allowing the cutting line to automatically load in both ends of the trimmer head 12. Numeral 15 designates a stud attached to a gear box (not shown) at the end of the shaft inside the upper portion 14.

The cover device 10 comprises a cover body including a disc-shaped bottom plate 20 having a diameter W at least slightly greater than the diameter of the knob 14 and an attachment assembly 26, as will be described in more, detail hereinafter. The bottom plate 20 has a pre-determined thickness H, which is substantially greater than a thin bottom wall of conventional trimmer head covers. In one aspect of the invention, the bottom plate 20 is between 0.125″ and 0.5″ in thickness. In some embodiments, the bottom plate is about 0.125″ thick. In another aspect, the bottom plate has a diameter substantially greater than the diameter of the attachment assembly 26 and the knob 14. The bottom plate 20 is provided with a rounded upwardly turned circumferential outer edge 21.

The bottom plate 20 has a top surface 22 and a bottom surface 24. The bottom surface 24 is substantially smooth and protrusion free, so as to prevent gouging of the lawn and ground during the landscape trimming operation. The curved edge 21 smoothly connects the bottom surface 24 with the top surface 22.

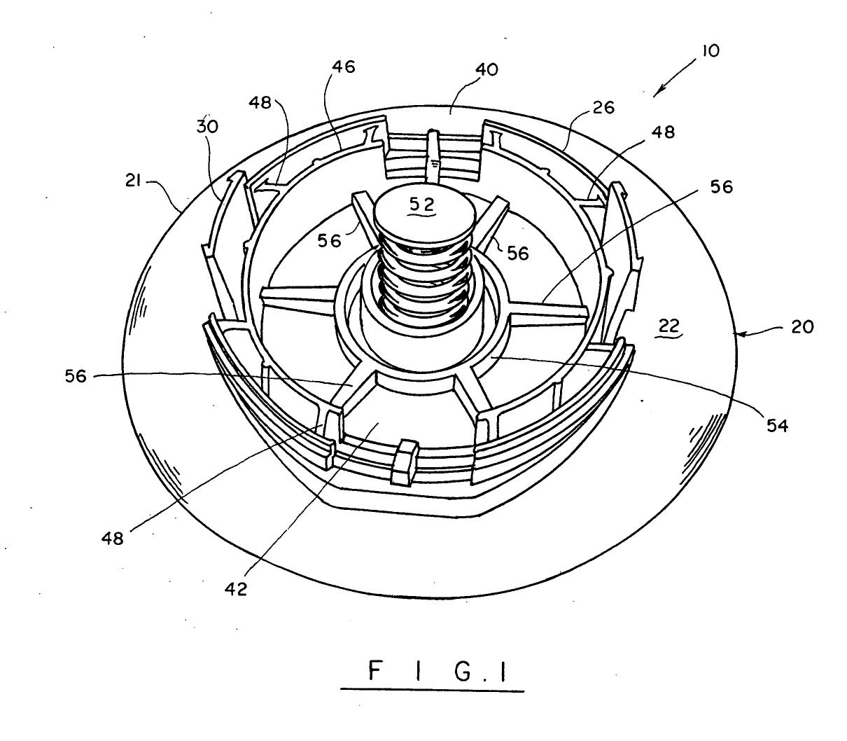

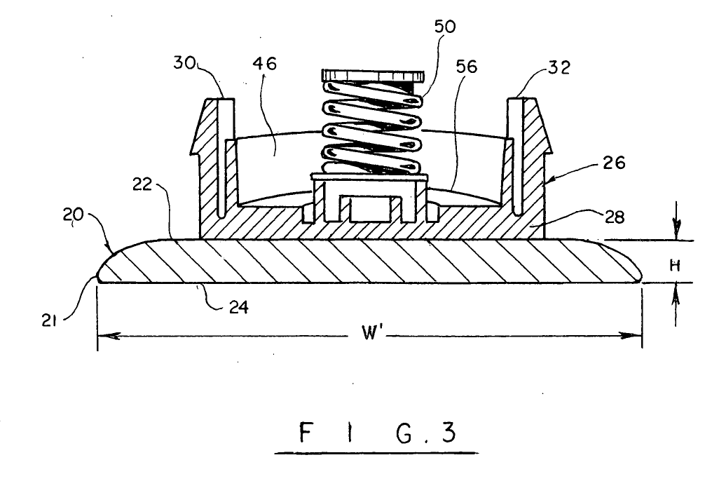

Extending upwardly from the top surface 22 of the bottom plate 20 is an attachment assembly 26, which comprises an upwardly extending outer cylindrical wall 28, formed with a pair of diametrically-opposing tabs 30, 32. The outer wall 28 and the tabs 30, 32 are formed from a resilient relatively rigid material. The tabs 30, 32 are configured to detachably engage with cutouts 34, 36, respectively, formed in the knob 14. The bottom plate 20 forms a collar surrounding the attachment assembly 26, as can be seen in FIGS. 1-3.

The outer wall 28 is provided with opposing U-shaped cutouts 40, 42 configured for engagement with the eyelets 16 of the knob 14. An inner wall 46 is secured to the outer wall 28 and is retained in a generally parallel spaced-apart parallel relationship to the outer wall 28 by a plurality of vertical reinforcing ribs 48 equidistantly spaced about the circumference of the annual space defined by the inner wall 46 and the outer wall 28.

A resilient coil spring 50, which forms no part of the instant invention, is positionable in the center of the cover 10. The spring 50 is configured to normally urge against the top surface 22 of the bottom plate 20 and a cap 52 fitted with its lower part, inside the coil spring 50. The top of the cap 52 contacts the spool (not shown) mounted inside the housing 12.

The spring 50 is positionable, in part, within a retaining ring 54, which is affixed to the top surface 22 of the bottom plate 20 inwardly of the inner wall 46. The retaining ring 54 extends upwardly from the top surface 22 to stabilize the spring 50. The spring 50 and the cap 52 are not fixed in their position but rather detachably mounted in the cover device 10.

Radiating from the retainer ring 54 is a plurality of radial ribs 56, which extend between the retainer ring 54 and the inner wall 46. The radial ribs 56 further reinforce the structure of the attachment assembly 26 by absorbing vibrations imparted on the cover 10 during rotation of the trimmer head 12.

The cover 10 is configured as a replacement or retrofit for a conventional cover of a trimmer head. To mount the cover 10, the user must first remove the conventional bottom cover by pressing the tabs on both sides of the bottom cover and pulling the bottom cover apart from the knob 14. The user then aligns the cover device 10 of the present invention with the knob 14 of the trimmer head 12 such that the cutouts 40, 42 are aligned with the eyelets 16. The user then presses the cover device 10 against the resistance of the spring 50 against the knob 14 until the tabs 30, 32 snap into the cutouts 34, 36 formed in the knob 14. The trimmer head 12 is then secured to a straight or curved shaft 60 of the trimmer apparatus, while the guard 62 protects the operator from flying debris during trimming.

The bottom plate 20 has at least slightly greater diameter than conventional bottom walls of the trimmer head covers. In one aspect, the bottom plate is about ⅝″ in diameter. Since it has protrusion-free bottom surface it glides along the ground in case of an occasional contact with the ground without causing damage to the lawn or soil.

The bottom plate can be manufactured from a variety of non-corrosive materials. In one aspect of the invention, the bottom plate 20 is formed from a synthetic resin and shaped as a disc. In another aspect, the bottom plate is unitary formed with the attachment assembly 26 by conventional manufacturing methods, such as for instance injection molding, from the same material as the attachment assembly 26. The bottom plate 20 is smooth and durable; its larger diameter allows the trimmer head 12 to tap on the ground to advance line, while the bottom surface 24 glides on the grass and soil during trimming. The cover device 10 is configured to fit Shindaiwa trimmers and brush cutters, although other manufacturers' models can be used with a slightly different change in design. It is envisioned that adapter hardware will be available to fit with most all other manufacturers' models.

Many changes and modifications can be made in the design of the present invention without departing from the spirit thereof. I, therefore, pray that my rights to the present invention be limited only by the scope of the appended claims.

I claim:

1. A cover device for a landscape trimmer head having a string head and a knob, the cover device comprising:
a cover body having a disc-shaped bottom plate and an attachment assembly secured to the bottom plate and extending upwardly therefrom, said attachment assembly being configured for detachable engagement with a trimmer head knob, said bottom plate having a diameter at least slightly greater than a diameter of the attachment assembly and the trimmer head knob.

2. The cover device of claim 1, wherein the bottom plate comprises a smooth protrusion-free bottom surface and a top surface.

3. The cover device of claim 2, wherein the attachment assembly is secured to the top surface of the bottom plate.

4. The cover device of claim 1, wherein the bottom plate forms a collar surrounding the attachment assembly.

5. The cover device of claim 1, wherein the attachment assembly comprises a cylindrical outer wall carrying a pair of resilient engagement tabs configured for engagement with the knob of the trimmer head.

6. The cover device of claim 5, wherein the attachment assembly further comprises an inner wall retained in a spaced-apart generally parallel relationship to the outer wall.

7. The cover device of claim 5, wherein a plurality of reinforcing ribs is secured in an annular space defined between the outer wall and the inner wall.

8. The cover device of claim 1, wherein the attachment assembly is configured to form a hollow housing, when engaged with the knob of the trimmer head, said housing being adapted for receiving a cutting string spool therein.

9. The cover device of claim 6, wherein the attachment assembly is provided with a retainer ring secured to the bottom plate inwardly of the inner wall, said retainer ring being configured for receiving a compression spring therein.

10. The cover device of claim 9, wherein a plurality of radial ribs extend between the retainer ring and the inner wall.

11. The device of claim 1, wherein the bottom plate has an upwardly turned rounded circumferential edge.

12. A cover device for a landscape trimmer head having a string head and a knob, the cover device comprising:
a cover body having a disc-shaped bottom plate and an attachment assembly secured to the bottom plate and extending upwardly therefrom, said attachment assembly being configured for detachable engagement with a trimmer head knob, said bottom plate having a substantially greater diameter than a diameter of the attachment assembly and the trimmer head knob, said bottom plate forming a larger diameter collar surrounding the attachment assembly.

13. The cover device of claim 12, wherein the bottom plate comprises a smooth protrusion-free bottom surface and a top surface, and wherein the attachment assembly is secured to the top surface of the bottom plate, extending outwardly therefrom.

14. The cover device of claim 12, wherein the attachment assembly is configured to form a hollow housing, when engaged with the knob of the trimmer head, said housing adapted to receive a cutting string spool therein.

15. The device of claim 12, wherein the bottom plate has an upwardly turned rounded circumferential edge.

16. The cover device of claim 12, wherein the attachment assembly comprises a cylindrical outer wall carrying a pair of resilient engagement tabs configured for engagement with the knob of the trimmer head and an inner wall retained in a spaced-apart generally parallel relationship to the outer wall by a plurality of reinforcing ribs secured in an annular space defined between the outer wall and the inner wall.

17. The cover device of claim 16, wherein the attachment assembly is provided with a retainer ring secured to the bottom plate inwardly of the inner wall, said retainer ring being configured for receiving a compression spring therein.

18. The cover device of claim 16, wherein a plurality of radial ribs extend between the retainer ring and the inner wall.

19. A method of retrofitting a landscape trimmer having a trimmer head including a string head and a knob, the method comprising the steps:
providing a cover device comprising a bottom plate and an attachment assembly configured for detachable engagement with the string head and the knob, said bottom plate forming an enlarged diameter collar surrounding the attachment assembly; and
engaging the cover device with the knob of the trimmer head, while retaining the string head between the cover device and the knob.

20. The method of claim 19, wherein the attachment assembly comprises a cylindrical outer wall carrying a pair of resilient engagement tabs configured for engagement with the knob of the trimmer head and an inner wall retained in a spaced-apart generally parallel relationship to the outer wall by a plurality of reinforcing ribs secured in an annular space defined between the outer wall and the inner wall.

21. The method of claim 20, wherein the step of engaging the cover device to the knob of the trimmer head comprises the step of snapping the engagement tabs with the knob of the trimmer head.

22. The method of claim 19, wherein the bottom plate has a smooth protrusion free bottom surface.

23. The method of claim 19, wherein the bottom plate is formed from a non-corrosive material.

24. The method of claim 19, wherein the bottom plate is formed from a synthetic resin.

25. The method of claim 19, wherein the bottom plate has an upwardly turned rounded circumferential edge.
